(19) United States
(12) Patent Application Publication
(10) Pub. No.: US 2024/0312179 A1
(43) Pub. Date: Sep. 19, 2024

(54) ADAPTIVE CONCEPT GENERATION BASED ON IMAGE CONTEXT

(71) Applicant: AI QUALISENSE 2021 LTD, Tel Aviv-Yafo (IL)

(72) Inventor: Adam Zrehen, Tel Aviv-Yafo (IL)

(73) Assignee: AI QUALISENSE 2021 LTD, Tel Aviv-Yafo (IL)

(21) Appl. No.: 18/608,807

(22) Filed: Mar. 18, 2024

Related U.S. Application Data
(60) Provisional application No. 63/490,534, filed on Mar. 16, 2023.

(51) Int. Cl. G06V 10/74; G06T 7/11

(52) U.S. Cl. CPC G06V 10/761; G06T 7/11

(57) ABSTRACT

A method for adaptive concept generation based on image context, the method include generating concepts that includes similarity thresholds for evaluating the similarity of received image sub-patches to reference image sub-patches of known properties.

### BACKGROUND OF THE INVENTION

A manufacturing process may produce different populations of manufactured items, whereas each population has a unique population distribution, whereas different population distributions may differ from each other-especially a good manufactured item of one population may differ from a good manufactured item of another population.

A defect detection process of the manufactured items may be inaccurate without making a distinction between the different populations.

There is a growing need to provide a method for accurately detecting defects.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates an example of a method;

FIG. 2 illustrates an example of a method;

FIG. 3 illustrates an example of a comparison and a data structures;

FIG. 4 illustrated an example of a comparison; and

FIG. 5 illustrates a system according to an embodiment of the invention.

### DETAILED DESCRIPTION OF THE DRAWINGS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system should be applied mutatis mutandis to a method that may be executed by the system and should be applied mutatis mutandis to a non-transitory computer readable medium that stores instructions that may be executed by the system.

Any reference in the specification to a non-transitory computer readable medium should be applied mutatis mutandis to a system capable of executing the instructions stored in the non-transitory computer readable medium and should be applied mutatis mutandis to method that may be executed by a computer that reads the instructions stored in the non-transitory computer readable medium.

Ideally, concepts generated at a certain image location should be highly representative of all images at that location. In some situations, there is high variability at a specific location due to the presence of a mixed population of data. If these populations are highly dissimilar, it is desirable to split the concept into two or more concepts, as necessary.

Images may be segmented to patches that may be segmented to sub-patches. The segmentation may be repeated multiple times to provide smaller and smaller sub-patches.

A patch which is a surrounding of a sub-patch can assist in determining the relevant population-(to provide context) and this may be used to define a similarity threshold to the sub-patch-whereas the similarity threshold is determined based on similarity scores related to sub-patches of the surrounding.

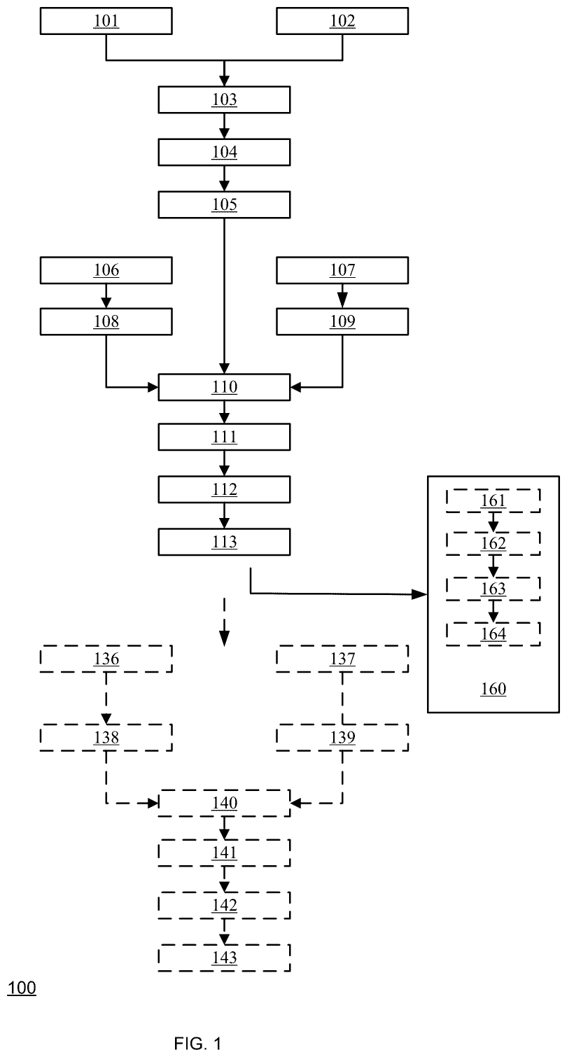

FIG. 1 is an example of method 100 for adaptive concept generation based on image context.

Method 100 may include steps 101 till 113.

Step 101 of generating multiple reference patch representations (RPRs) that represent multiple reference image patches (IPs), based on multiple reference images.

Step 102 of generating multiple training patch representations (TPRs) that represents multiple training IPs, based on multiple training images.

Step 103 of calculating similarities between the multiple TPRs and the multiple RPRs.

Step 104 of finding, for each reference IP, an associated set of similar training Ips.

Step 105 of generating reference patch concepts, wherein each reference patch concept comprises a reference IP and a reference IP similarity threshold, wherein the reference IP similarity threshold is determined based on similarities between the reference IP and members of the associated set of similar training IPs. For example—the similarity threshold may not exceed any similarity between the reference IP any member of the set of similar training IPs, but may be higher than a similarity between the reference IP and training IPs that do not belong to the set. For example—if the set included the most N1 (first number) similar training IPs, then the (N1+1)′th most similar training IP will be less similar to the reference IP than the similarity threshold.

Step 106 of segmenting the reference IPs to provide reference image sub-patches (ISPs).

Step 107 of segmenting the training IPs to provide training ISPs.

Step 108 of generating multiple reference sub-patch representations (RSPRs) that represent the ISPs.

Step 109 of generating multiple training sub-patch representations (TSPRs) that represent the TSPs.

Step 110 of calculating for each reference IP, calculating similarities between RSPRs related to the reference IP and TSPRs that are related to an associated set of similar training IPs that is associated with the reference IP;

Step 111 of finding, for each reference ISP, an associated set of similar training ISPs.

Step 112 of generating reference sub-patch concepts, wherein each reference sub-patch concept comprises a reference ISP and a reference ISP similarity threshold, wherein the reference ISP similarity threshold is determined based on similarities between the reference ISP and members of the associated set of similar training ISPs.

Step 113 of storing the reference patch concepts, the reference sub-patch concepts. The reference sub-patch concepts may be used during inference.

Step 110 may include avoiding from calculating, for each reference IP, similarities between RSPRs related to the reference IP and TSPRs that are not related to an associated set of similar training IPs that is associated with the reference IP. The avoiding dramatically reduces the amount of calculations required to implement method 100. The avoiding also maintains the context of the patches in the sub-patch concepts—as the similarities are evaluated only in relation to associated test sub-patches.

The associated set of similar training IPs may include a first number of most similar training IPs. The first number may be determined in any manner—may be, for example a certain percentage of the training Ips, and the like.

The associated set of similar training ISPs may include a second number of most similar training ISPs. The second number may be determined in any manner—may exceed the first number, may equal the first number or may be smaller than the first number.

Method 100 may be executed in relation to manufactured items—and the reference images may capture reference manufactured items. The training images may capture training manufactured items.

The training manufactured items and the reference manufactured items may be different instances of the same manufactured item. The training manufactured items and the reference manufactured items may be ideally identical to each other—may be identical to each under when manufactured by an ideal defect free manufactured item.

While steps 101-113 provide patches and sub-patches-steps 106-112 may be repeated, mutatis mutandis, to provide sub-sub-patches and sub-sub-patches concepts to be used during inference—and that multiple repetitions of steps 106-112 may be executed to provide image parts of increasing resolution.

An example of another repetition may include:
a. Step 136 of segmenting the reference ISPs to provide reference image sub-sub-patches (ISSPs).
b. Step 137 of segmenting the training ISPs to provide training ISSPs.
c. Step 138 of generating multiple reference sub-sub-patch representations (RSSPRs) that represent the ISSPs.
d. Step 139 of generating multiple training sub-sub-patch representations (TSSPRs) that represent the TSSPs.
e. Step 140 of calculating, for each reference ISP, similarities between RSSPRs related to the reference ISP and TSSPRs that are related to an associated set of similar training ISPs that is associated with the reference ISP.
f. Step 141 of finding, for each reference ISSP, an associated set of similar training ISSPs.
g. Step 142 of generating reference sub-sub-patch concepts, wherein each reference sub-sub-patch concept comprises a reference ISSP and a reference ISSP similarity threshold, wherein the reference ISSP similarity threshold is determined based on similarities between the reference ISSP and members of the associated set of similar training ISSPs.
h. Step 143 of storing the reference patch concepts, the reference sub-patch concepts and the reference sub-sub-patches.

Method 100 may be executed in relation to manufactured items—and the reference images may capture reference manufactured items. The training images may capture training manufactured items.

Step 140 may include avoiding from calculating, for each reference ISP, similarities between RSSPRs related to the reference ISP and TSSPRs that are not related to an associated set of similar training ISPs that is associated with the reference ISP.

Method 100 may include inference step 160.

Step 160 may include:
a. Step 161 of receiving a received image.
b. Step 162 of generating received ISP representations.
c. Step 163 of searching for at least one matching reference sub-patch concept to provide a search result. A matching reference sub-patch concept comprises a reference image sub-patch that is similar to a received ISP representation by at least a reference ISP similarity threshold of the reference sub-patch concept.
d. Step 164 of responding to the finding.

Step 164 may include determining a status of an object captured by the received image—for example defective or not.

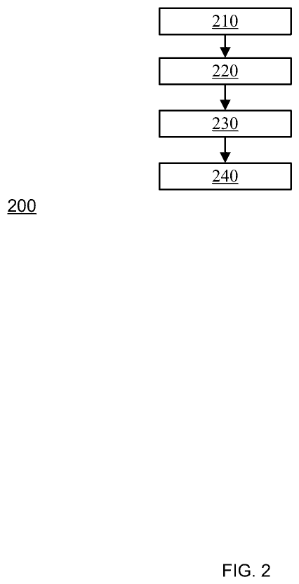

FIG. 2 illustrates method 200 for defect detection. It is assumed, for simplicity of explanation, that the defect detection is related to manufactured items.

Method 200 may start by step 210 of receiving a received image.

Step 210 may be followed by step 220 of generating received ISP representations. This may include segmenting the received image to sub-patches and generating representations of the sub-patches. A representation may be a feature vector, a signature, and the like.

Step 210 may be followed by step 230 of searching for at least one matching reference sub-patch concept to provide a search result.

A matching reference sub-patch concept includes a reference image sub-patch that is similar to a received ISP representation by at least a reference ISP similarity threshold of the reference sub-patch concept. The searching may include comparing the received ISP representation to representations of reference image sub-patched that may be generated by applying method 100 (or at least by applying some steps of method 100).

Step 230 may be followed by step 240 of responding to the finding.

Step 240 may include determining a status of an object captured by the received image—for example whether the object is defective or not. This may include finding that the object includes defects that appear in defective reference sub-patches, by finding that a matching reference sub-patch concept is indicative of an good or defective sub-patch, by failing to find a matching reference sub-patch concept that is associated with a good object, and the like.

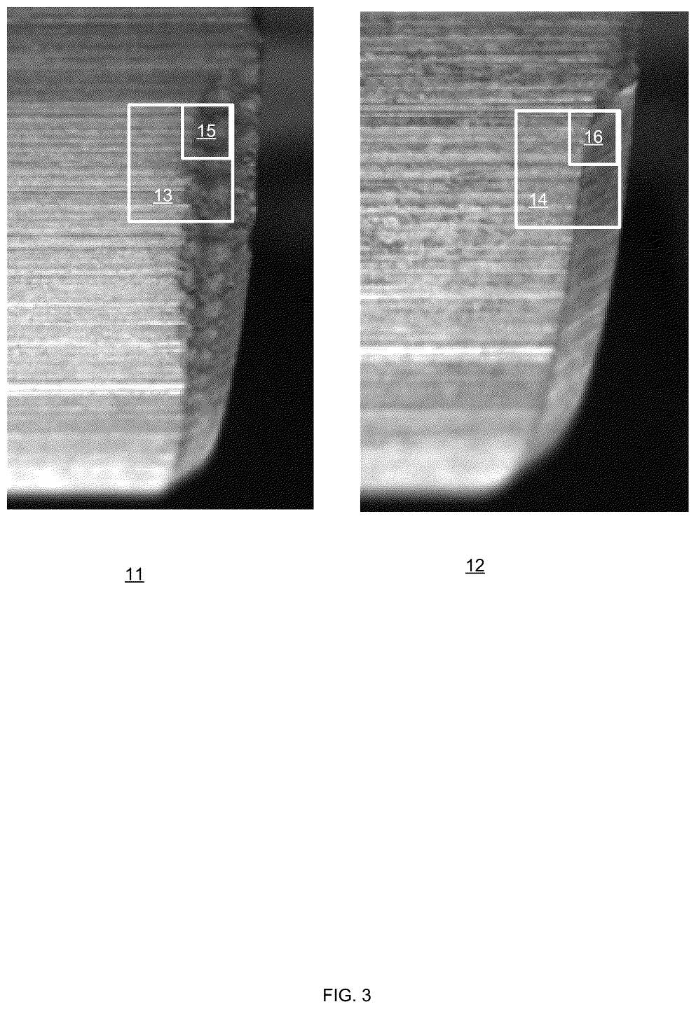

FIG. 3 illustrates images 11 and 12 of parts of manufactured items that belong to different populations, patches 13 and 14 and sub-patches 15 and 16.

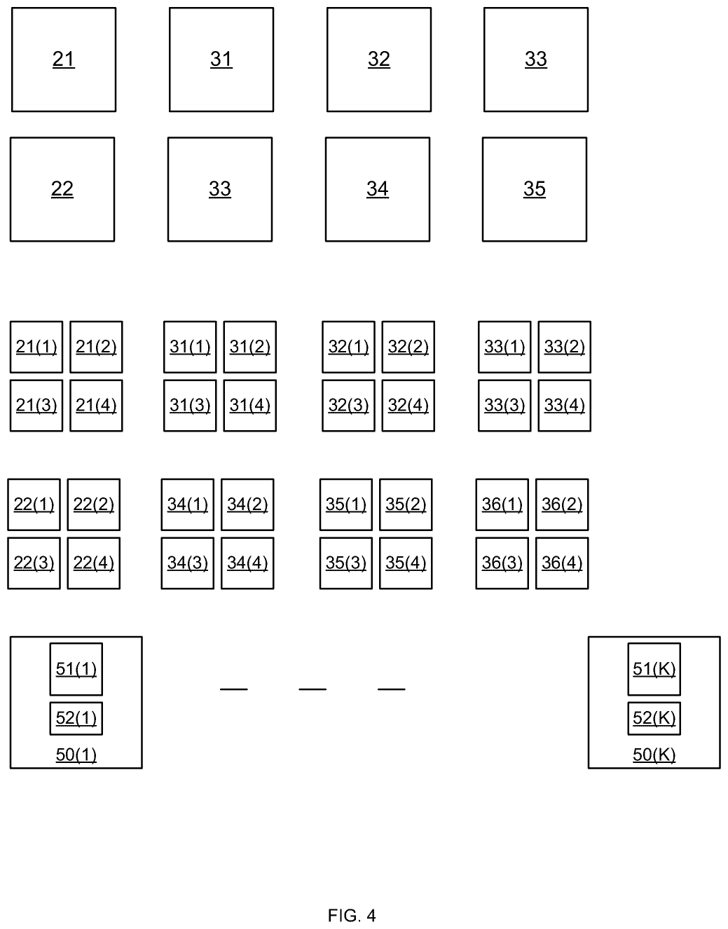

FIG. 4 illustrates an example of a first reference image patch 21, a first associated set of similar training IPs that includes three testing image patches 31, 32 and 33, a second reference image patch 22, a second associated set of similar training IPs that includes three other testing image patches 34, 35 and 36.

FIG. 4 also illustrates an example of first reference image sub-patches 21(1), 21(2), 21(3) and 21(4), and training sub-patches 31(1), 31(2), 31(3), 31(4), 32(1), 32(2), 32(3), 32(4), 33(1), 33(2), 33(3), and 33(4). The training sub-patches are related to the three testing image patches 31, 32 and 33. Similarities are evaluated between first reference image sub-patches 21(1), 21(2), 21(3) and 21(4) and training sub-patches 31(1), 31(2), 31(3), 31(4), 32(1), 32(2), 32(3), 32(4), 33(1), 33(2), 33(3), and 33(4). Similarities between first reference image sub-patches 21(1), 21(2), 21(3) and 21(4) and other training sub-patches may not be calculated.

FIG. 4 further illustrates an example of second reference image sub-patches 22(1), 22(2), 22(3) and 22(4), and training sub-patches 34(1), 34(2), 34(3), 34(4), 35(1), 35(2), 35(3), 35(4), 36(1), 36(2), 36(3), and 36(4). The training sub-patches are related to the three testing image patches 34, 35 and 36. Similarities are evaluated between second reference image sub-patches 22(1), 22(2), 22(3) and 22(4) and training sub-patches 34(1), 34(2), 34(3), 34(4), 35(1), 35(2), 35(3), 35(4), 36(1), 36(2), 36(3), and 36(4). Similarities between second reference image sub-patches 22(1), 22(2), 22(3) and 22(4) and other training sub-patches may not be calculated.

FIG. 4 also illustrates sub-patches concepts 50(1)-50(K) that include sub-patches 51(1)-51(K) and sub-patches similarity thresholds 52(1)-52(K).

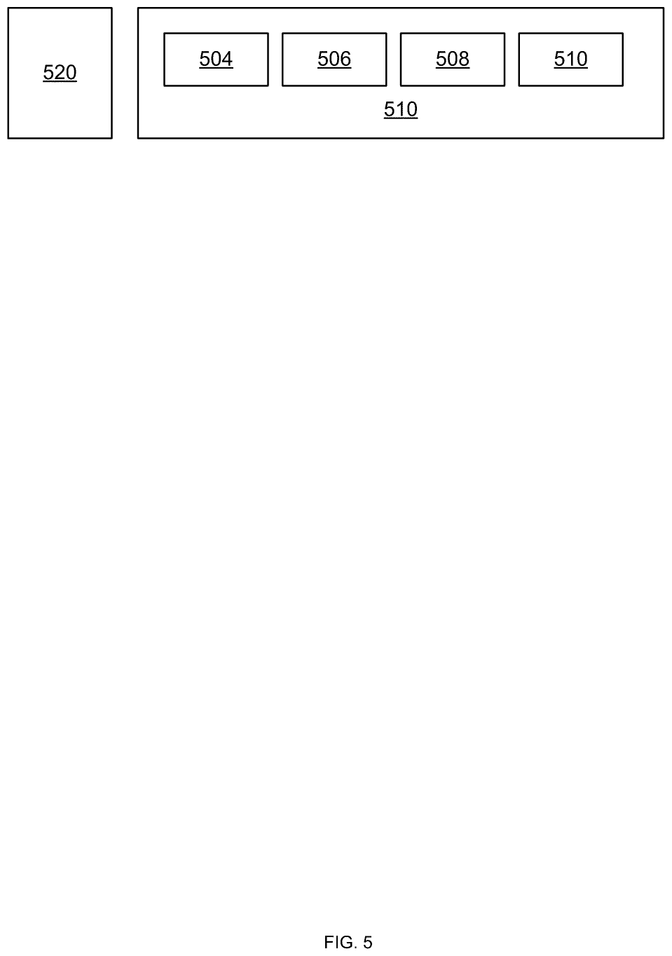

FIG. 5 is an example of a computerized system 500 and a manufacturing process tool 520.

The computerized system 500 may execute method 200.

The computerized system 500 may or may not communicate with the manufacturing process tool 520. It may, for example, provide feedback (for example the process variation alert) about the manufacturing process applied by the manufacturing process tool 520 (that manufactured the evaluated manufactured items) and/or for receiving images of the evaluated manufactured items, and the like. The computerized system 500 may be included in the manufacturing process tool 520.

The computerized system 500 may include communication unit 504, memory 506, processor 508 and may optionally include a man machine interface 510.

Processor may execute the steps of method 200, Memory 506 is configured to store any data element illustrated in FIG. 2.

Method 100 may be executed by computerized system 500 or by any other computerized system.

Any of the suggested method may be executed by a computerized device that may include one or more processing circuits, memory for storing images and/or anomaly spatial information and/or instructions and/or the outcome of method 100, and a communication unit for communication with other systems and/or devices.

The invention may also be implemented in a computer program for running on a computer system, at least including code portions for performing steps of a method according to the invention when run on a programmable apparatus, such as a computer system or enabling a programmable apparatus to perform functions of a device or system according to the invention. The computer program may cause the storage system to allocate disk drives to disk drive groups.

A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

The computer program may be stored internally on a non-transitory computer readable medium. All or some of the computer program may be provided on computer readable media permanently, removably or remotely coupled to an information processing system. The computer readable media may include, for example and without limitation, any number of the following: magnetic storage media including disk and tape storage media; optical storage media such as compact disk media (e.g., CD-ROM, CD-R, etc.) and digital video disk storage media; nonvolatile memory storage media including semiconductor-based memory units such as flash memory, EEPROM, EPROM, ROM; ferromagnetic digital memories; MRAM; volatile storage media including registers, buffers or caches, main memory, RAM, etc.

A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input, and responds by allocating and managing tasks and internal system resources as a service to users and programs of the system.

The computer system may for instance include at least one processing unit, associated memory and a number of input/output (I/O) devices. When executing the computer program, the computer system processes information according to the computer program and produces resultant output information via I/O devices.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

The connections as discussed herein may be any type of connection suitable to transfer signals from or to the respective nodes, units or devices, for example via intermediate devices. Accordingly, unless implied or stated otherwise, the connections may for example be direct connections or indirect connections. The connections may be illustrated or described in reference to being a single connection, a plurality of connections, unidirectional connections, or bidirectional connections. However, different embodiments may vary the implementation of the connections. For example, separate unidirectional connections may be used rather than bidirectional connections and vice versa. Also, plurality of connections may be replaced with a single connection that transfers multiple signals serially or in a time multiplexed manner. Likewise, single connections carrying multiple signals may be separated out into various different connections carrying subsets of these signals. Therefore, many options exist for transferring signals.

Although specific conductivity types or polarity of potentials have been described in the examples, it will be appreciated that conductivity types and polarities of potentials may be reversed.

Each signal described herein may be designed as positive or negative logic. In the case of a negative logic signal, the signal is active low where the logically true state corresponds to a logic level zero. In the case of a positive logic signal, the signal is active high where the logically true state corresponds to a logic level one. Note that any of the signals described herein may be designed as either negative or positive logic signals. Therefore, in alternate embodiments, those signals described as positive logic signals may be implemented as negative logic signals, and those signals described as negative logic signals may be implemented as positive logic signals.

Furthermore, the terms “assert” or “set” and “negate” (or “deassert” or “clear”) are used herein when referring to the rendering of a signal, status bit, or similar apparatus into its logically true or logically false state, respectively. If the logically true state is a logic level one, the logically false state is a logic level zero. And if the logically true state is a logic level zero, the logically false state is a logic level one.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

Also for example, the examples, or portions thereof, may implemented as soft or code representations of physical circuitry or of logical representations convertible into physical circuitry, such as in a hardware description language of any appropriate type.

Also, the invention is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as ‘computer systems’.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

We claim:

1. A method for adaptive concept generation based on image context, the method comprises:
(a) generating multiple reference patch representations (RPRs) that represent multiple reference image patches (IPs), based on multiple reference images;
(b) generating multiple training patch representations (TPRs) that represents multiple training IPs, based on multiple training images;
(c) calculating similarities between the multiple TPRs and the multiple RPRs;
(d) finding, for each reference IP, an associated set of similar training IPs;
(e) generating reference patch concepts, wherein each reference patch concept comprises a reference IP and a reference IP similarity threshold, wherein the reference IP similarity threshold is determined based on similarities between the reference IP and members of the associated set of similar training Ips;
(f) segmenting the reference IPs to provide reference image sub-patches (ISPs);
(g) segmenting the training IPs to provide training ISPs;
(h) generating multiple reference sub-patch representations (RSPRs) that represent the ISPs;
(i) generating multiple training sub-patch representations (TSPRs) that represent the TSPs;
(j) for each reference IP, calculating similarities between RSPRs related to the reference IP and TSPRs that are related to an associated set of similar training IPs that is associated with the reference IP;
(k) finding, for each reference ISP, an associated set of similar training ISPs;
(l) generating reference sub-patch concepts, wherein each reference sub-patch concept comprises a reference ISP and a reference ISP similarity threshold, wherein the reference ISP similarity threshold is determined based on similarities between the reference ISP and members of the associated set of similar training ISPs; and
(m) storing the reference patch concepts, the reference sub-patch concepts.

2. The method according to claim 1, comprising avoiding from calculating, for each reference IP, similarities between RSPRs related to the reference IP and TSPRs that are not related to an associated set of similar training IPs that is associated with the reference IP.

3. The method according to claim 1, wherein the associated set of similar training IPs comprises a first number of most similar training IPs.

4. The method according to claim 1, wherein the associated set of similar training ISPs comprises a second number of most similar training ISPs.

5. The method according to claim 1, wherein the reference images capture reference manufactured items.

6. The method according to claim 1, comprising:
(a) segmenting the reference ISPs to provide reference image sub-sub-patches (ISSPs);
(b) segmenting the training ISPs to provide training ISSPs;
(c) generating multiple reference sub-sub-patch representations (RSSPRs) that represent the ISSPs;
(d) generating multiple training sub-sub-patch representations (TSSPRs) that represent the TSSPs;
(e) for each reference ISP, calculating similarities between RSSPRs related to the reference ISP and TSSPRs that are related to an associated set of similar training ISPs that is associated with the reference ISP;
(f) finding, for each reference ISSP, an associated set of similar training ISSPs;
(g) generating reference sub-sub-patch concepts, wherein each reference sub-sub-patch concept comprises a reference ISSP and a reference ISSP similarity threshold, wherein the reference ISSP similarity threshold is determined based on similarities between the reference ISSP and members of the associated set of similar training ISSPs; and
(h) storing the reference patch concepts, the reference sub-patch concepts and the reference sub-sub-patches.

7. The method according to claim 6, comprising avoiding from calculating, for each reference ISP, similarities between RSSPRs related to the reference ISP and TSSPRs that are not related to an associated set of similar training ISPs that is associated with the reference ISP.

8. The method according to claim 1 comprising:
receiving a received image;
generating received ISP representations;
searching for at least one matching reference sub-patch concept to provide a search result; wherein a matching reference sub-patch concept comprises a reference image sub-patch that is similar to a received ISP representation by at least a reference ISP similarity threshold of the reference sub-patch concept; and
responding to the finding.

9. The method according to claim 8 wherein the responding comprising determining a status of an object captured by the received image.

10. A non-transitory computer readable medium for adaptive concept generation based on image context, the non-transitory computer readable medium storage instructions that cause a processor to:
(a) generate multiple reference patch representations (RPRs) that represent multiple reference image patches (IPs), based on multiple reference images;
(b) generate multiple training patch representations (TPRs) that represents multiple training IPs, based on multiple training images;
(c) calculate similarities between the multiple TPRs and the multiple RPRs;
(d) find, for each reference IP, an associated set of similar training IPs;
(e) generate reference patch concepts, wherein each reference patch concept comprises a reference IP and a reference IP similarity threshold, wherein the reference IP similarity threshold is determined based on similarities between the reference IP and members of the associated set of similar training IPs;
(f) segment the reference IPs to provide reference image sub-patches (ISPs);
(g) segment the training IPs to provide training ISPs;
(h) generate multiple reference sub-patch representations (RSPRs) that represent the ISPs;
(i) generate multiple training sub-patch representations (TSPRs) that represent the TSPs;
(j) for each reference IP, calculate similarities between RSPRs related to the reference IP and TSPRs that are related to an associated set of similar training IPs that is associated with the reference IP;
(k) find, for each reference ISP, an associated set of similar training ISPs;
(l) generate reference sub-patch concepts, wherein each reference sub-patch concept comprises a reference ISP and a reference ISP similarity threshold, wherein the reference ISP similarity threshold is determined based on similarities between the reference ISP and members of the associated set of similar training ISPs; and
(m) store the reference patch concepts, the reference sub-patch concepts.
